(19) United States
(12) Patent Application Publication
(10) Pub. No.: US 2003/0225518 A1
(43) Pub. Date: Dec. 4, 2003

(54) Tailgating break warning system

(76) Inventor: Mark Christopher Layne, Dolton, IL (US)

Correspondence Address: Mark and Tracy Layne, 14501 South Harper, Dolton, IL, 60419, US

(21) Appl. No.: 10/160,617

(22) Filed: Jun. 4, 2002

(51) Int. Cl. G06F 17/10

(52) U.S. Cl. 701/301; 340/435

(57) ABSTRACT

The Tailgating Break Warning System is a break warning system that prevents a vehicle from following too closely and thereby decreasing the chances of a rear end collision from the vehicle that is following behind. When a vehicle recognizes that the vehicle trailing behind is approaching or following too closely, the person in the vehicle can manually activate the brake lights without actually slowing their vehicle down. Thus the tailgater, thinking the vehicle has slowed down, will brake (or slow down) their own vehicle increasing the distance between the two vehicles.

### CROSS-REFERENCE TO RELATED APPLICATIONS

This is not a continuation-in-part of a previous application or one that is co-pending.

### FEDERALLY SPONSORED RESEARCH OR DEVELOPMENT STATEMENT

None of the work on this invention was performed under any Federally or State sponsored research and development.

### BACKGROUND OF INVENTION (FIELD OF INVENTION)

The Tailgating Break Warning System can prevent fender benders due to vehicles following too closely behind another vehicle. The most common occurrences of car collisions are a result of persons following or driving at an unsafe distance between vehicles. One-way to tell if you're following too closely is, for every 10 miles per hour, your vehicle should be a car length behind the vehicle in front of you. So, if your going sixty miles per hour, your vehicle should be six car lengths behind, however, it's a fact, some may be tailgating and not even know it. Recent studies have shown that in one state where 600,000 accidents were looked at, it was determined that 40 percent of those accidents were rear end collisions, due more than likely, from tailgating.

Presently there are no warning systems to prevent tailgating, although most accidents occur from people following too closely. This Tailgating Break Warning System is an inexpensive and very cost affective way used at a driver's discretion to prevent tailgating, which will lessen the risk of a minor collision. This invention operates independent of any other system(s) that may be available or proposed because these systems require the use of equipment such as receivers, transmitters, control units, etc., that must be placed upon every car or widely used in order to be effective.

### BRIEF SUMMARY OF INVENTION

This tailgating break warning system allows a person driving their vehicle to use, at their discretion, a warning signal that tells the vehicle behind that they are following to closely. When a vehicle activates the tailgating warning system, the vehicle is giving the elusion that his/her vehicle is slowing down and therefore, this system invokes a natural response from the person trailing behind to slow down. Because this is only an elusion of the vehicle breaking, it does not put the vehicle at risk of being hit by the vehicle trailing behind. But instead because the trailing vehicle naturally slows down, the trailing vehicle is putting a safer driving distance between the two cars that can prevent a rear end collision.

### DETAILED DESCRIPTION OF INVENTION

The Tailgating Break Warning System is composed of three different colored electrical wires (preferably red, black and white (or yellow if white is not found)) and a push button switch. For the colored wires, red is generally positive, black is negative and white/yellow is ground. There are three connectors on the push button switch. One is positive, one is negative and one is a ground.

You would connect the appropriate colored wires to each connector on the button of the switch by soldering the connector. (Example: the red positive wire would be connected to the positive connector on the push button switch).

Locate the vehicle fuse box, generally underneath the dashboard. Find the taillight fuse and remove it from its location within the fuse box.

Wrap the positive wire around one end of the fuse and then wrap the negative wire around the opposite end of the same fuse (it does not matter which sides the positive and negative wires will be wrapped).

Carefully replace the taillight fuse back into its location within the fuse box making sure the wires remain or stay on the connectors. The wires must connect to the metal of the fuse otherwise their will be no connection.

Now locate a screw against the body of the vehicle. This screw can be on the floorboard, under the dash or anywhere on the body of the vehicle. Unloosen that screw and wrap the ground wire (white or yellow in color) around the head of that screw and then retighten the screw.

Drill a hole in the dashboard, take the cap off of the push button switch and put the button through the hole then fasten/screw the nut to the front of the dash, securing the button in its place then replace push button head.

What I claim as my invention is:

1. A Tailgating Break Warning System wherein vehicle A is driving along and notices through the rear view mirror that the vehicle B directly behind is tailgating or following too closely; therefore to prevent the tailgating, the person in said vehicle A, manually pushes a button (the Tailgating Break Warning System) to give off the impression to said Vehicle B, who is following too closely (tailgater) that vehicle A is slowing down; and vehicle B, the tailgater, will naturally slow down his/her vehicle allowing for a safer distance between the two vehicles, without adding to the risk of vehicle A by actually slowing down, in turn, preventing a rear end collision.
